(19) United States
(12) Patent Application Publication
(10) Pub. No.: US 2026/0309134 A1
(43) Pub. Date: Oct. 8, 2026

(54) IMPROVED MULTI-CYLINDER HYDRAULIC MACHINE

(71) Applicant: POCLAIN HYDRAULICS INDUSTRIE, Verberie (FR)

(72) Inventors: Julien Viard, Verberie (FR); Gilles Lemaire, Verberie (FR); Yoann Rousseau, Verberie (FR); Jean-Pierre Souply, Verberie (FR)

(73) Assignee: POCLAIN HYDRAULICS INDUSTRIE, Verberie (FR)

(21) Appl. No.: 19/482,563

(22) PCT Filed: May 6, 2024
(86) PCT No.: PCT/FR2024/050598

§ 371 Date: Nov. 7, 2025

(30) Foreign Application Priority Data
May 10, 2023 (FR) FR2304636

(51) Int. Cl. F04B 1/1071; F04B 5/00

(52) U.S. Cl. CPC F04B 1/1071; F04B 5/00

(57) ABSTRACT

A hydraulic machine having each pair formed by a piston and a housing defines between the piston and the housing a first chamber and a second chamber which are separate from one another, the cylinder block and the distributor each have a plurality of inner ducts defining a first set of ducts and a second set of ducts. The sets of ducts opening open onto the interface between the distributor and the cylinder block at two separate radii with respect to the main axis and being are suitable for respectively supplying the first chambers and the second chambers.

### TECHNICAL FIELD

This invention relates to a multiple-displacement hydraulic machine having an improved distribution structure.

### PRIOR ART

Multiple-displacement hydraulic machines are known and commonly used. Such hydraulic machines have several values of displacement which can be engaged, to offer several modes of operation. Examples include hydraulic machines offering a first mode delivering a high torque at low speed, and a second mode delivering a reduced torque at a high speed.

Such hydraulic machines offer an advantageous degree of flexibility while being of small bulk.

A recurring difficulty for the production of such hydraulic machines relates to the distribution of fluid. This is because the production of such multiple displacements generally involves complex structures for the associated distributor. One may in particular cite the document FR2836960 which has the structure of a multiple-displacement hydraulic motor with a specific distributor.

This invention aims to at least partially respond to this problem.

### SUMMARY OF THE INVENTION

This invention thus relates to a hydraulic machine comprising:
a first assembly and a second assembly, rotationally movable with respect to one another about a main axis,
the first assembly comprising a casing and a multilobe cam,
the second assembly comprising a shaft, a cylinder block, the cylinder block having a plurality of housings in which pistons slide, each piston being positioned in a housing,
the hydraulic machine further comprising a distributor suitable for providing the supply and discharge of fluid, the distributor bearing against the cylinder block along an interface extending radially with respect to the main axis,
characterized in that
each pair formed by a piston and a housing defines between the piston and the housing a first chamber and a second chamber which are separate from one another,
the cylinder block and the distributor each have a plurality of inner ducts defining a first set of ducts and a second set of ducts, said sets of ducts opening onto the interface between the distributor and the cylinder block at two separate radii with respect to the main axis and being suitable for respectively supplying the first chambers and the second chambers.

According to an example, the shaft extends outside the casing, and is suitable for transmitting or receiving a rotational movement and/or torque.

According to an example, the cam extends around the cylinder block with respect to the main axis, and the cylinder block is configured in such a way that the pistons slide radially with respect to the main axis during the relative rotation between the first assembly and the second assembly.

According to an example, the distributor is a grooved distributor.

According to an example, the distributor is a pad-mounted distributor, having at least one distribution plate at the interface between the distributor and the cylinder block.

According to an example, the distributor comprises two concentric distribution plates; a first distribution plate suitable for connecting the ducts of the first set of ducts, and a second distribution plate suitable for connecting the ducts of the second set of ducts.

According to an example, for each pair formed by a piston and a housing, the first chamber has a displacement strictly greater than the second chamber.

According to an example, for each torque formed by a housing and a piston, the first chamber and the second chamber have different effective areas.

According to an example, for each pair formed by a housing and a piston, the first chamber has an effective area strictly greater than the second chamber.

According to an example, for each pair formed by a housing and a piston, the first chamber has an effective area strictly less than the second chamber.

According to an example, each housing has a first portion having a first section S1, and a second portion having a second section S2, the first section S1 being strictly greater than the second section S2, the first portion extending from an outer surface of the cylinder block, and the second portion extending from the first portion. The pistons are typically configured in such a way as to define an effective area during operation, in such a way that the effective area of the first chambers is strictly greater than the effective area of the second chambers.

According to an example, for each pair formed by a piston and a housing, the first chamber and the second chamber are superimposed along a direction of sliding of the piston in the housing.

According to an example, the set of the first chambers define a homokinetic motor or pump, and the set of the second chambers define a homokinetic motor or pump.

For a hydraulic motor, the homokinetic characteristic means that, when the fluid supply flow is constant, the rotation speed of the rotating part of the motor, typically the cylinder block or the cam, is substantially constant. In other words, the rotation occurs with no jolts. In a homokinetic motor, the fluid balance is substantially zero, i.e. at any time, the amount of fluid entering the cylinder blocks is substantially equal to the amount of fluid exiting the cylinders.

For a hydraulic pump, the homokinetic characteristic means that when the speed of rotation of the rotary part is constant, the fluid flow discharged by the pump is constant. In other words, the flow delivered does not have any surges.

Insofar as a constant flow circulates through the different ducts for a constant rotation speed of the hydraulic machine, there is no acceleration or deceleration of the fluid in the ducts, which in particular makes it possible to reduce load losses and therefore to increase the efficiency of the machine.

According to an example, the set of the first chambers defines a first hydraulic sub-machine which operates by the collaboration of the pistons sliding in these first chambers with a multilobe cam and which is configured in such a way that said first hydraulic sub-machine is homogenous. The term “homogenous” means that at constant rotation (of the cylinder block) for each cam lobe, the flow circulating in the first chambers, the pistons of which travel the cam lobe in question, is constant. An example of a hydraulic machine with a homogenous flow is described in the patent application WO2023/242502A1 to which those skilled in the art may refer.

When the hydraulic machine (or sub-machine) associates a particular means of distribution with a lobe or a group of lobes of the multilobe cam, the fact that the hydraulic machine (or sub-machine) is homogenous allows a constant flow to circulate in the ducts of this distribution means assigned to this lobe or group of lobes for a constant rotation speed of the hydraulic machine (or sub-machine).

Insofar as a constant flow circulates in the different ducts of the distribution system dedicated to a lobe or to a group of lobes for a constant rotation speed of the hydraulic machine, there is no acceleration or deceleration of the fluid in the ducts of the distribution system dedicated to this lobe or to this group of lobes, which in particular makes it possible to reduce the load losses and therefore to increase the efficiency of the hydraulic machine or sub-machine.

According to an example, the set of the second chambers defines a second hydraulic sub-machine which operates by the collaboration of the pistons sliding in these second chambers with a multilobe cam configured such that said second hydraulic sub-machine is homogenous.

According to an example the profile of the cam is non-sinusoidal. The non-sinusoidal cam in particular allows for profiles which allow the homokinesis or homogeneity of the hydraulic machine (or sub-machine).

According to an example the profile of the cam in particular has cam flats. What those skilled in the art refer to as a “cam flat” is a part of the cam for which, for a given angular sector of the cam, the radius of the profile of the cam does not vary. Consequently a piston crossing a cam flat does not move in its housing and does not generate any flow. This in particular makes it possible to avoid, for example, pressure spikes in the chamber being created during the transition from one distribution orifice to the other. This in particular makes it possible to space the distribution orifices apart from one another to improve the seal, avoiding leaks from the high-pressure ducts toward the low-pressure ducts at the distribution face.

This invention also relates to an assembly comprising a hydraulic machine as previously defined, and a displacement-changing valve suitable for selectively supplying pressure to the first set of ducts and/or the second set of ducts.

According to an example, said assembly further comprises a displacement selector,
said displacement selector defines at least two configurations in which the first chambers and/or the second chambers are supplied for separate sets of angular sectors of the cam.

According to an example, the displacement selector comprises a first selector valve, which defines at least two separate configurations in which the first chambers are supplied when positioned facing separate sets of angular sectors of the cam, and a second selector valve which defines at least two separate configurations in which the seconds chambers are supplied when positioned facing separate sets of angular sectors of the cam.

The fact of mutualizing the displacement change by piston stages (first and second chambers) and the cam lobes (angular sectors) has the advantage of ensuring an exchange between the bypassed sub-circuit and the main circuit when the machine is operating with a reduced displacement, which improves the thermal behavior of a machine that would run for a long time at reduced displacement by the piston stages. Specifically, if one reduces only the displacement of the hydraulic machine, for example solely by supplying the first chambers, the oil in the second chambers (non-effective) would not necessarily be renewed and would tend to heat due to the back-and-forth of the pistons in their housings and due to its circulation through the ducts.

### BRIEF DESCRIPTION OF THE DRAWINGS

The invention and its advantages will be better understood on reading the detailed description given hereinafter of different embodiments of the invention given by way of non-limiting example.

FIG. 1 schematically represents a multiple-displacement hydraulic machine.

FIG. 2 shows a structure of a cylinder block of a multiple-displacement hydraulic machine according to an aspect of the invention.

FIG. 3 shows an example of a structure of a multiple-displacement hydraulic machine according to an aspect of the invention.

FIG. 4 shows another example of a structure of a multiple-displacement hydraulic machine according to an aspect of the invention.

FIG. 5 shows an example of a structure of a multiple-displacement hydraulic machine according to an aspect of the invention.

FIG. 6 shows an example of a structure of a distributor for a hydraulic machine according to an aspect of the invention.

FIG. 7 another example of a structure of a distributor for a multiple-displacement hydraulic machine according to an aspect of the invention.

In all the figures, elements in common are identified by identical reference numbers.

### DESCRIPTION OF THE EMBODIMENTS

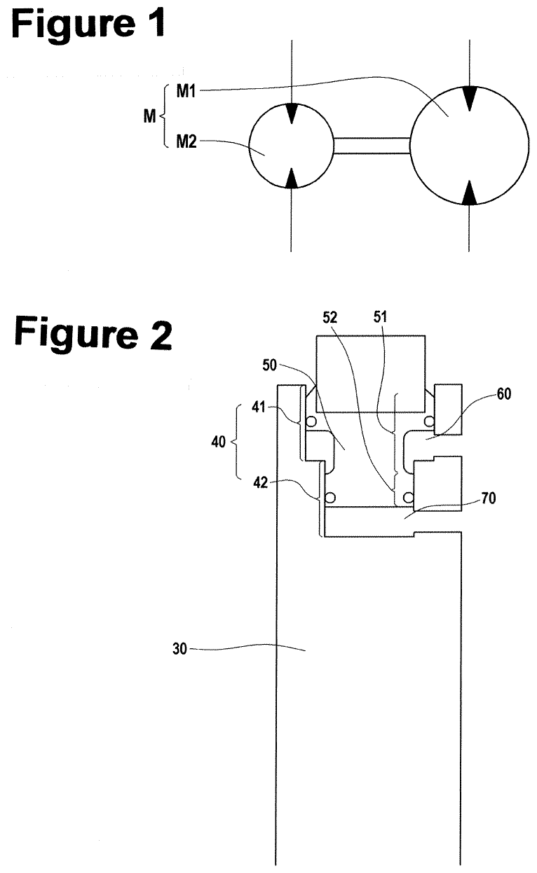

FIG. 1 is a schematic representation of a multiple-displacement hydraulic machine. In the illustrated example, a hydraulic motor M is schematized as being composed of two rotationally coupled hydraulic sub-motors M1 and M2. One and/or the other of the two hydraulic sub-motors M1 and M2 may be selectively engaged, typically by controlling the intake and discharge of the two hydraulic sub-motors M1 and M2. It will be understood that this figure can also be transposed for a hydraulic pump composed of two hydraulic sub-pumps.

FIGS. 2, 3 and 5 illustrate an embodiment of a multiple-displacement hydraulic machine according to an aspect of the invention. The hydraulic machine may have the operation of a hydraulic motor or of a hydraulic pump.

FIG. 2 shows a partial view of a cylinder block 30 defining a housing 40 in which a piston 50 slides, typically suitable for being kept in contact with a cam, for example a multilobe cam. In operation, the pistons follow the cam. Thus, the pistons make back-and-forth movements in their respective housings according to the geometry of the cam, while remaining in contact with the cam.

A multilobe cam is a cam formed in such a way as to have corrugations or lobes, such that a piston in a cylinder block housing shown centered with respect to the came and remaining in contact with the cam makes back-and-forth movements in its housing during rotation.

The cam is typically non-sinusoidal. A non-sinusoidal profile of the cam in particular makes it possible to produce a cam profile that makes it possible to produce a homokinetic or homogenous hydraulic machine (or sub-machine) as will be seen further on.

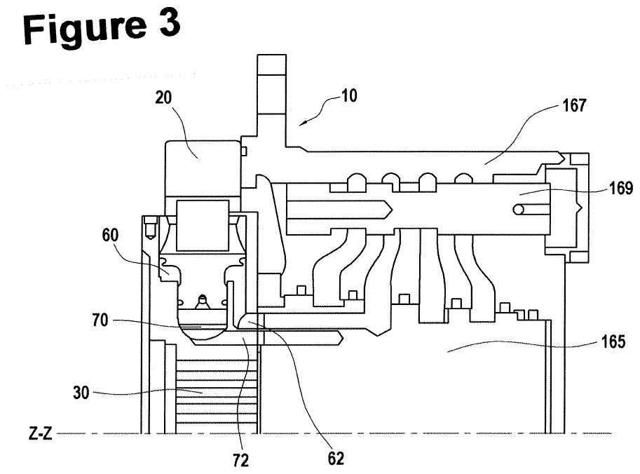

FIG. 3 shows a more complete view, comprising a cam 20 and a casing 10. The cam 20 is positioned in such a way as to surround the cylinder block 30 with respect to the main axis Z-Z. The casing 10 and the cam 20 define an inner volume in which is housed the cylinder block 30. The cylinder block 30 is secured to a shaft 32 mounted rotationally movably with respect to the casing 10 by means of bearings 12. The cylinder block 30 and the shaft 32 form a rotationally movable assembly with respect to the assembly formed by the cam 20 and the casing 10 by means of a shaft 32 defining the main axis Z-Z. The shaft 32 typically extends outside the casing 10, and is suitable for receiving or transmitting a rotational movement and/or torque according to whether the hydraulic machine has the operation of a hydraulic pump or of a hydraulic motor. In the illustrated example, the cam surrounds the cylinder block. In a variant, the adapter 100 can have a radial architecture with an inner cam mounted rotationally movably with respect to the cylinder block 30 and to a casing 10, the cylinder block 30 then being typically rotationally secured with the casing 10.

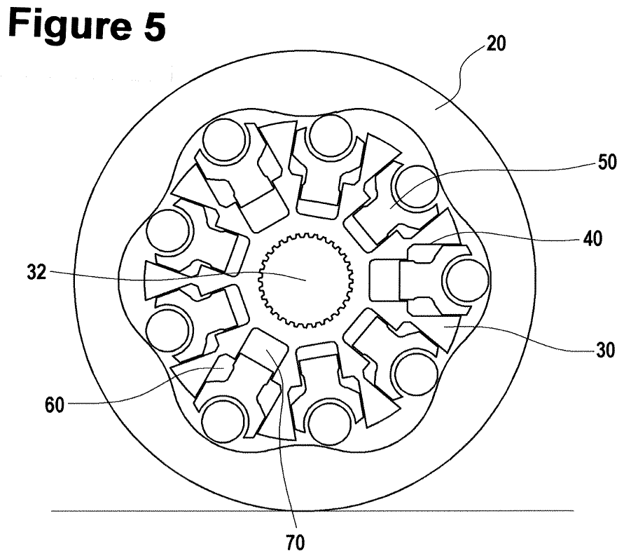

FIG. 5 shows an example of a radial machine structure. This figure shows a cylinder block 30 surrounded by a multilobe cam 20. In this example, the cylinder block 30 comprises 9 housings and the cam defines 6 lobes.

In the illustrated example, the hydraulic machine has a radial structure. The term “radial structure” should be understood to mean that the pistons 50 and the housings 40 are disposed in such a way as to define a movement of the pistons 50 along a radial direction with respect to the main axis Z-Z. In the remainder of the description, the radial direction refers to a radial direction with respect to the main axis Z-Z.

In the structure proposed by this invention, each pair formed by a piston 50 and a housing 40 defines a first chamber 60 and a second chamber 70 which are separate from one another, isolated from one another by means of sealing elements.

The first chamber 60 and the second chamber 70 are typically superimposed along the direction of sliding of the piston 50 in the housing 40, here the radial direction with respect to the main axis Z-Z.

In the illustrated example, the housing 40 has two separate portions; a first portion 41 having a first section S1, and a second portion 42 having a second section S2, the first section S1 being strictly greater than the second section S2,the first portion extending from an outer surface of the cylinder block 30 and opening out opposite the cam, and the second portion 42 extending from the first portion 41 in such a way as to form the bottom of the housing 40. The second portion 42 is thus typically blind along the direction of sliding of the pistons 50.

The piston 50 also has a first portion 51 and a second portion 52 suitable for respectively sliding in the first portion 41 and the second portion 42 of the housing 40 while ensuring the sealing of the first chamber 60 and of the second chamber 70.

Such a structure makes it possible to define, in a single cylinder block and over a single row of pistons coming into contact with one and the same cam, two separate hydraulic machines via the first chambers 60 and the second chambers 70. The two hydraulic machines thus formed may have identical or separate displacements, that will be respectively referred to as C1 and C2. The displacement is defined as the product of the effective area production of a chamber under consideration by the stroke of the piston, the effective area of a piston being the total surface of the piston that participates in creating a force tending to displace the piston in the desired direction. A distinction is made between the displacement for a given piston and the displacement for a motor or a pump, which is equal to the sum of the displacement of the pistons for the motor or the pump under consideration. The displacement C1 of the first chambers 60 is thus defined by the stroke of the piston multiplied by the effective area of the first chambers 60. The displacement C2 of the second chambers 70 is thus defined by the stroke of the piston multiplied by the effective area of the second chambers 70. The proposed structure thus makes it possible to embody a structure allowing a multiple-displacement operation with a restricted number of pistons and lobes and with one and the same row of pistons, which is advantageous in terms of compactness and therefore of integration.

For each pair formed by a housing and a piston, the first chamber 60 and the second chamber 70 thus typically have separate effective areas. The first chamber 60 can thus have an effective area strictly greater than the second chamber 70, or conversely, the first chamber 60 can thus have an effective area strictly smaller than the second chamber 70.

The displacement of the hydraulic machine can thus be modulated by supplying or not supplying the first chambers 60 and/or the second chambers 70. The hydraulic machine can thus have a displacement equal to C1, to C2, or to C1+C2.

Each of the two hydraulic machines thus formed typically defines a homokinetic hydraulic machine; for a constant rotation speed of the cylinder block 30 with respect to the cam 20, the first chambers 60 and/or the second chambers 70 deliver a constant or substantially constant flow, particularly by contrast with an oscillating linear actuator which delivers a pulsed pressure.

The set of first chambers 60 typically defines a first hydraulic sub-machine which operates by the collaboration of the pistons 50 sliding in these first chambers 60 with the multilobe cam 20 configured in such a way that said first hydraulic sub-machine is homogenous. The term “homogenous” means that at constant rotation (of the cylinder block) for each cam lobe 20, the flow circulating in the first chambers 60, the pistons 50 of which traverse the cam lobe 20 in question is constant. An example of a hydraulic machine with homogenous flow is described in the patent application WO2023/242502A1 to which those skilled in the art may refer.

When the hydraulic machine (or sub-machine) combines a particular means of distribution for a lobe or a group of lobes of the multilobe cam 20, the fact that the hydraulic machine (or sub-machine) is homogenous allows a constant flow to circulate through the ducts of this distribution means assigned to this lobe or group of lobes for a constant rotation speed of the hydraulic machine (or sub-machine).

Insofar as a constant flow is circulating through the different ducts of the distribution system dedicated to a lobe or to a group of lobes for a constant rotation speed of the hydraulic machine, there is no acceleration or deceleration of the fluid in the ducts of the distribution system dedicated to this lobe or to this group of lobes, which in particular makes it possible to reduce the load losses and therefore to increase the efficiency of the hydraulic machine or sub-machine.

According to an example, the set of the second chambers 70 defines a second hydraulic sub-machine which operates by the collaboration of the pistons 50 sliding in these second chambers 70 with a multilobe cam configured such that said second hydraulic sub-machine is homogenous.

Ducts 62 and 72 are fashioned in the cylinder block 30, these ducts extending respectively from the first chambers 60 and from the second chambers 70 and opening out from a lateral surface of the cylinder block 30. The ducts 62 and 72 are then supplied by a distributor 165.

The cylinder block 30 thus comprises ducts 62 and 72 opening out opposite the distributor 165, making it possible to connect the first chambers 60 and the second chambers 70 to the distributor 165. The ducts 62 and 72 typically open out at an interface between the cylinder block 30 and the distributor 165, the interface being typically between two surfaces extending radially with respect to the main axis Z-Z.

The conducts 62 and 72 formed in the cylinder blocks 30 open out at separate positions with respect to the main axis Z-Z; for example the ducts connected to the first chambers 60 are centered on a circle of radius R1 with respect to the main axis Z-Z, and the ducts connected to the second chambers 70 are centered on a circle of radius R2 with respect to the main axis Z-Z with R1 different from R2. In the illustrated example, R1 is strictly greater than R2, the first chambers 60 being located radially outward with respect to the second chambers 70. The distributor 165 has inner ducts suitable for opening onto the interface between the distributor 165 and the cylinder block, opposite the ducts 62 and 72, and thus making it possible to provide the supply and discharge of the first chambers 60 and second chambers 70. One may thus define a first set of ducts making it possible to supply the first chambers 60, comprising ducts internal to the distributor 165 and the duct 62 internal to the cylinder block. One may also define a second set of ducts making it possible to supply the second chambers 70, comprising ducts internal to the distributor 165 and the duct 72 internal to the cylinder block.

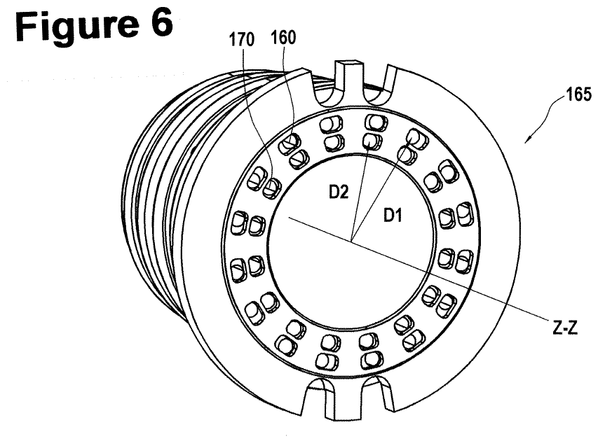

FIG. 6 illustrates an example of such a distributor 165. This figure shows a front view of the distributor 165 arriving at the interface with the cylinder block 30. The reference number 160 here denotes the ducts internal to the distributor 165 suitable for arriving opposite the ducts 62 and 64 of the cylinder block 30 extending from the first chambers 60, and the reference 170 denotes the ducts internal to the distributor 165 suitable for arriving opposite the ducts 72 and 74 of the cylinder block 30 extending from the second chambers 70. It can be seen that the inner ducts 160 are disposed in a circle of radius D1 with respect to the main axis Z-Z, and that the inner ducts 170 are disposed in a circle of radius D2 with respect to the main axis Z-Z, such that D1>D2.

Such a structure makes it possible to simplify the connection of the chambers to the distributor, and thus to simplify the general structure of the distributor 165 by comparison with known structures.

On this FIG. 6, the ducts 160 and 170 internal to the distributor 165 which supply one and the same piston open out onto the distribution face of the distributor 165 on one and the same radius (they are angularly aligned). However, they could be angularly offset to open onto the distribution face in a staggered arrangement (this makes it possible to put more material between the orifices of the distributor 165 and therefore to increase the mechanical resistance of this material to forces-particularly those due to fluid pressure).

In the same way, the orifices of the ducts 62 of the cylinder block 30 opening onto the distribution interface which supply/discharge the chambers 60 can be angularly offset (with respect to the axis of rotation of the hydraulic machine) from the orifices of the ducts 72 of the cylinder block which supply the chambers 70. Thus, the orifices of the supply/discharge ducts 62 of the first chambers 60 may be offset in a staggered arrangement from the orifices of the supply/discharge ducts 72 of the second chambers on the cylinder block.

In the example illustrated in FIG. 6 it can be seen that the distribution orifices of the ducts 160 on the distributor 165 extend over the same angle as the distribution orifices of the ducts 170 (for an equivalent radial extent the surface of the orifices of the ducts 160 is greater than the surface of the orifices of the ducts 170). It could be otherwise and in particular, the distribution orifices of the ducts 160 could have an angular extent less than or greater than the strict angular extent of the distribution orifices of the ducts 170. The same applies for the radial extent. Thus, the hydraulic machine can for example adjust, by design, the surface of the distribution orifices as a function of the flow that it wishes to pass through the first chambers 60 or through the second chambers 70. In the example illustrated on FIG. 3, the distributor 165 is a grooved distributor. It particularly comprises a distribution cover 167 equipped with a displacement-changing valve 169, suitable for selectively connecting the different ducts 62 and 72 to an intake or a discharge of fluid formed in the casing or in the distribution cover 167.

By way of example, considering an operation as a motor, the displacement-changing valve 169 can in particular make it possible to connect the first 60 and/or the second 70 chambers to the intake in order to obtain an operation with a displacement equal to C1, C2 or C1+C2. By way of example, in the scenario in which only the second chambers 70 are supplied, the first chambers 60 may be connected to a reservoir R, or be connected to one another and isolated from the intake and from the discharge. The operation of a displacement selector is of course known and will therefore not be detailed here.

The displacement-changing valve 169 can be integrated into the distribution cover 167 or to the casing 10 or to the distributor 165, or again be added on to the casing 10.

In a variant, the distributor 165 may be a pad-mounted distributor.

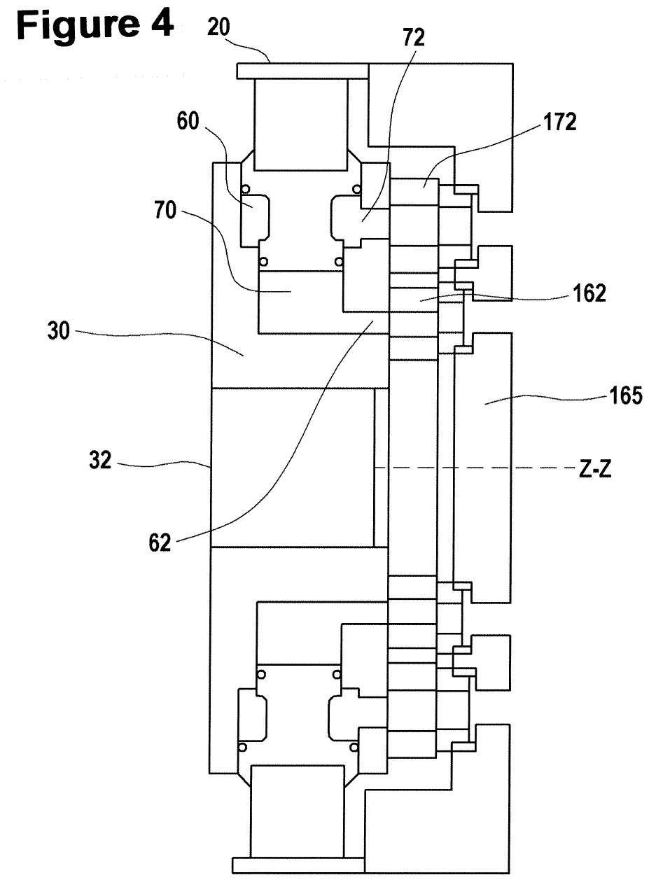

FIG. 4 schematically illustrates such a variant. Here only the elements differing from the FIG. 3 previously described will be indicated. A pad-mounted distributor typically comprises a distribution part or plate interposed between the cylinder block 30 and the casing 10, comprising distribution orifices suitable for putting in communication supply and discharge ducts formed in the casing 10, and ducts formed in the cylinder block 30. The interposed distribution plate can for example take the form of a ring or of a disc centered with respect to the main axis Z-Z. In the illustrated example, two distribution plates 162 and 172 of annular shape are interposed between the distributor and the cylinder block 30, respectively facing the ducts 62 and 72.

In a variant, the distributor may have a single distribution plate, typically of annular shape, having drill holes formed facing the ducts 62 and 72.

Optionally, the distributor 165 can be suitable for providing the supply and discharge of fluid in the first chambers 60 and/or in the second chambers 70 for a first angular sector and for a second angular sector.

The term “angular sector” should be understood to mean an angular subdivision of the multilobe cam 20 or a group of angular subdivisions adjoining or disjoint from the cam 20. For example, an angular sector as defined here may contain several lobes or several half-lobes of the multilobe cam 20, optionally disjoint. As indicated previously, the distributor 165 is typically configured in such a way as to make it possible to produce a variation in the displacement of the hydraulic machine by engaging or not engaging the first chambers 60 and/or the second chambers 70. Such a functionality makes it possible to obtain different displacement values, namely a zero displacement, a displacement equal to C1, a displacement equal to C2, or a displacement equal to C1+C2.

Optionally, the distributor 165 may be configured in such a way as to modify the angular sector for which the first chambers 60 and/or the second chambers 70 are engaged.

The came 20 is typically a multilobe cam comprising a plurality of lobe portions. The distributor 165 may be configured in such a way as to have several operating modes, for example an operating mode in which it makes it possible to provide a supply of fluid to the first chambers 60 over the entirety of the lobe portions of the cam 20, and one or more other operating modes in which for certain lobe portions, the first chambers 60 are not supplied.

In the same way, according to the structure of the set, the distributor 165 may be configured in such a way as to have several operating modes, for example an operating mode in which it makes it possible to provide a supply of fluid to the second chambers 70 over the entirety of the lobe portions of the cam 20, and one or more other operating modes in which for certain lobe portions, the second chambers 70 are not supplied.

Such a disengagement of the first chambers 60 and/or of the second chambers 70 over a part of the angular sectors can in particular be embodied by connecting the ducts corresponding to one and the same orifice (intake or discharge), or by shutting off the fluid intake for the ducts corresponding to the disengaged angular sectors.

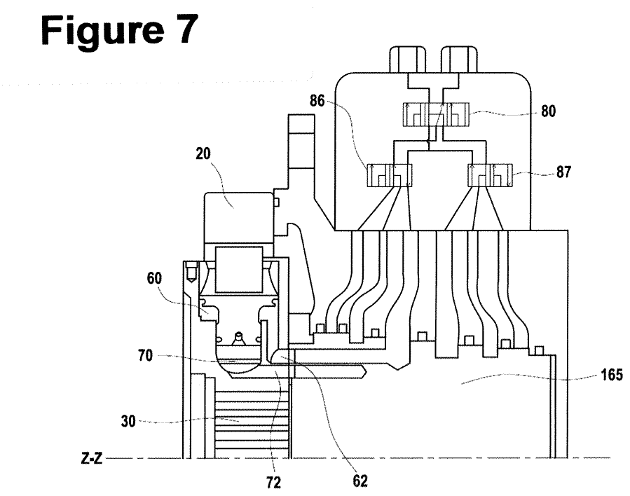

The control of the distributor 165 to define the supplied lobe portions can for example be embodied by means of a valve or several valves which can for example be integrated into the distributor 165 or be upstream or downstream of the distributor 165, typically upstream or downstream of the displacement-changing valve 169. FIG. 7 schematically shows a variant of FIG. 3 in which such valves are respectively denoted by the references 86 and 87 for the valves associated with the first chambers 60 and with the second chambers 70 respectively. These two valves 86 and 87 are connected to a displacement selector valve 80 making it possible to supply one and/or the other of the valves 86 and 87. The displacement selector valve 80 thus makes it possible to define which chambers from among the first and/or the second chambers 60 and 70 are supplied, while the valves 86 and 87 respectively define for the first chambers 60 and for the second chambers 70 the angular sectors for which they are supplied.

The system may thus for example comprise a first selector valve making it possible to define several separate sets of angular sectors, and making it possible to control the supply of the first chambers 60 according to these different sets of angular sectors. In the same way, the system may for example comprise a second selector valve making it possible to define several separate sets of angular sectors, and making it possible to control the supply of the second chambers 70 according to these different sets of angular sectors.

Such a structure makes it possible to embody a displacement control in two levels, via the supply to the chambers 60 and 70, and via the supply to the lobe portions, and thus makes it possible to increase the number of possible displacements for the hydraulic machine.

Thus, in addition to the displacements C1, C2 and C1+C2 mentioned previously, one may for example obtain additional displacements of type 0.5*C1 considering that the distributor 160 makes it possible to disengage the lobe portions corresponding to half of the displacement, or more generally additional displacements of type X*C1, X*C2 or X*(C1+C2), X corresponding to the ratio of lobe portions which are then active.

One may also have additional displacements of type X*C1, Y*C2 or X*C1+Y*C2, X corresponding to the ratio of lobe portions which are then made active to supply/discharge the first chambers 60, and Y corresponding to the ratio of lobe portions which are then made active to supply/discharge the second chambers 70.

According to the structure of the distributor and the means used, one may typically define several sets of lobe portions which can be selectively engaged or not engaged, thus defining several ratios of lobe portions to increase the number of possible combinations and displacements, thus offering additional functionality and operating modes.

In particular, in the example illustrated on FIG. 7 the distribution and displacement selection system does not allow for symmetric operation. However, the invention could be embodied with a symmetrical distribution and displacement selection system. In a hydraulic machine with symmetric distribution operating as a motor, reversing the pressure levels at the terminals thereof changes the direction of rotation while keeping an equivalent operation. In a hydraulic machine of symmetrical distribution operating as a pump, reversing the direction of rotation of the input shaft gives rise to a reversal of the pressure levels at the terminals thereof while keeping an equivalent operation.

Although this invention has been described with reference to specific exemplary embodiments, it is obvious that modifications and changes may be made to these examples without departing from the general scope of the invention as defined by claims. In particular, individual features of the different embodiments illustrated/mentioned may be combined in additional embodiments. Consequently, the description and drawings must be considered within an illustrative sense rather than a restrictive one.

It is also obvious that all the features described with reference to a method are transposable, alone or in combination, to a device, and conversely, all the features described with reference to a device are transposable, alone or in combination, to a method.

1. A hydraulic machine comprising:
a first assembly and a second assembly, rotationally movable with respect to one another about a main axis,
the first assembly comprising a casing and a multilobe cam,
the second assembly comprising a shaft, a cylinder block, the cylinder block having a plurality of housings in which pistons slide, each piston being positioned in a housing,
the hydraulic machine further comprising a distributor suitable for providing the supply and discharge of fluid, the distributor bearing against the cylinder block along an interface extending radially with respect to the main axis,
wherein
each pair formed by a piston and a housing defines between the piston and the housing a first chamber and a second chamber which are separate from one another,
the cylinder block and the distributor each have a plurality of inner ducts defining a first set of ducts and a second set of ducts, said sets of ducts opening onto the interface between the distributor and the cylinder block at two separate radii with respect to the main axis and being suitable for respectively supplying the first chambers and the second chambers.

2. The hydraulic machine as claimed in claim 1, wherein the shaft extends outside the casing, and is suitable for transmitting or receiving a rotational movement and/or torque.

3. The hydraulic machine as claimed in claim 1, wherein the cam extends around the cylinder block with respect to the main axis, and wherein the cylinder block is configured in such a way that the pistons slide radially with respect to the main axis during the relative rotation between the first assembly and the second assembly.

4. The hydraulic machine as claimed in claim 1, wherein the distributor is a grooved distributor, or wherein the distributor is a pad-mounted distributor, having at least one distribution plate at the interface between the distributor and the cylinder block.

5. The hydraulic machine as claimed in claim 1, wherein for each pair formed by a piston and a housing the first chamber has a displacement strictly greater than the second chamber.

6. The hydraulic machine as claimed in claim 1, wherein each housing has a first portion having a first section S1, and a second portion having a second section S2, the first section S1 being strictly greater than the second section S2, the first portion extending from an outer surface of the cylinder block, and the second portion extending from the first portion.

7. The hydraulic machine as claimed in one of claim 1, wherein for each pair formed by a piston and a housing, the first chamber and the second chamber are superimposed along a direction of sliding of the piston in the housing.

8. An assembly comprising a hydraulic machine as claimed in claim 1 and a displacement-changing valve suitable for selectively supplying pressure to the first set of ducts and/or the second set of ducts.

9. The assembly as claimed in claim 8, further comprising a displacement selector,
said displacement selector defines at least two configurations in which the first chambers and/or the second chambers are supplied for separate sets of angular sectors of the cam.

10. The assembly as claimed in claim 9, wherein the displacement selector comprises a first selector valve, which defines at least two separate configurations in which the first chambers are supplied when positioned facing separate sets of angular sectors of the cam, and a second selector valve, which defines at least two separate configurations in which the second chambers are supplied when positioned facing separate sets of angular sectors of the cam.
